(19) United States
(12) Patent Application Publication
(10) Pub. No.: US 2012/0259043 A1
(43) Pub. Date: Oct. 11, 2012

(54) RUBBER COMPOSITION CONTAINING AN EPOXIDIZED SYNTHETIC RUBBER, AND TIRE TREAD CONTAINING SAME

(75) Inventors: Garance Lopitaux, Valignat (FR); Didier Vasseur, Clermont-Ferrand (FR); Franck Varagniat, Ceyrat (FR)

(73) Assignee: SOCIETE DE TECHNOLOGIE MICHELIN, Clemont-Ferrand (FR)

(21) Appl. No.: 13/501,273

(22) PCT Filed: Oct. 12, 2010
(86) PCT No.: PCT/EP2010/065263

§ 371 Date: Jun. 26, 2012

(30) Foreign Application Priority Data
Oct. 14, 2009 (FR) 0957180

(51) Int. Cl. C08L 63/08; C08K 5/09

(52) U.S. Cl. 523/456

(57) ABSTRACT

The present invention relates to a rubber composition based on at least one elastomeric matrix comprising an epoxidized synthetic rubber (ESR) having an epoxy function content ranging from 7% to 25%, a reinforcing filler, of which at least 50% by weight of the reinforcing filler is constituted of an inorganic filler, and a plasticizing agent comprising a polar liquid plasticizer for the manufacture of a tyre tread having an improved compromise of properties: grip on wet ground/rolling resistance.

The present invention relates to rubber compositions intended, in particular, for the manufacture of tyres or of semi-finished products for tyres; it relates more particularly to rubber compositions based on epoxidized synthetic rubber (hereinbelow “ESR”) and plasticizing systems, which can be used for the manufacture of tyre treads.

As is known, a tyre tread has to meet a large number of often conflicting technical requirements, including a low rolling resistance, a high wear resistance and a high grip on both the dry road and the wet road.

The combined improvement of the rolling resistance and grip properties remains a constant concern of tyre designers.

It is known to use epoxidized natural rubber (ENR) elastomers in tyre treads for improving some of their usage properties, in particular the performances of grip on wet ground, rolling resistance and abrasion resistance, as described, for example, in documents U.S. Pat. No. 7,371,791, U.S. Pat. No. 6,220,323, EP 0644235 or EP 1577341.

It is also known from document US 2006/128868 A1 to use elastomers functionalized by one or more functions chosen from two categories of functions, amine or amide on the one hand and various functions including an epoxy function on the other hand, in other words an ESR, in a rubber composition possibly containing an extender oil used for the manufacture of tyre treads, based on synthetic diene elastomers chosen from homopolymers of isoprene and of 1,3-butadiene and copolymers of isoprene and of 1,3-butadiene with styrene, optionally as a blend with another synthetic diene elastomer, for the purpose of facilitating the working on tools, i.e. to improve the raw processability of the composition containing silica as reinforcing filler.

Furthermore, rubber compositions for tyres comprise, in a known way, plasticizing agents used for the preparation or synthesis of certain diene elastomers, for improving the raw processability of said compositions in the uncured state and also some of their usage properties in the cured state such as, for example, in the case of tyre treads, their grip on wet ground or else their abrasion and cut resistance.

In the continuance of their research, the Applicants have discovered that the use of a rubber composition comprising an ESR elastomer having an epoxy function content located in a range of values combined with a reinforcing filler and with a plasticizing agent, makes it possible to obtain a further improved compromise of properties, favourable to the grip on wet ground and the rolling resistance of tyre treads.

Thus, a first subject of the invention relates to a reinforced rubber composition, based at least on an elastomeric matrix comprising predominantly an epoxidized synthetic rubber (ESR) having an epoxy function content ranging from 7% to 25%, a reinforcing filler, of which at least 50% by weight of the reinforcing filler is constituted of an inorganic filler, and a plasticizing agent comprising a polar liquid plasticizer.

Another subject of the invention is the use of this reinforced rubber composition for the manufacture of tyres or of semi-finished products for tyres, in particular tyre treads.

Another subject of the invention is the use of this reinforced rubber composition for the manufacture of tyres or of semi-finished products for tyres, in particular tyre treads, whether the latter are intended for the manufacture of new tyres or for retreading used tyres in order to obtain improved grip on wet ground.

Another subject of the invention is these semi-finished products for tyres and these tyres themselves, when they comprise, completely or partly, a composition in accordance with the invention.

Another subject of the invention is a process for improving the grip on wet ground of a tyre or for improving both the grip on wet ground and the rolling resistance of a tyre.

The tyres of the invention are particularly intended to be fitted on motor vehicles of the passenger type, SUV (“Sport Utility Vehicles”) type, two-wheel vehicles (especially motorcycles) and aircraft, as well as industrial vehicles chosen from vans, heavy vehicles, i.e. underground trains, buses, heavy road transport vehicles (lorries, towing vehicles, trailers), off-road vehicles such as agricultural or civil-engineering vehicles, and other transport or handling vehicles.

The expression composition “based on” should be understood to mean a composition comprising the mixture and/or the reaction product of the various constituents used, some of these base constituents being able, or intended, to react at least partly with one another during the various phases for manufacturing the composition, in particular during the crosslinking or vulcanization thereof.

In the present description, unless expressly indicated otherwise, all the percentages (%) indicated are % by weight. Moreover, any interval of values denoted by the expression “between a and b” represents the range of values going from more than a to less than b (i.e. the limits a and b excluded) whereas any interval of values denoted by the expression “from a to b” means the range of values going from a to b (i.e. including the strict limits a and b).

The rubber composition according to the invention is therefore based at least on an elastomeric matrix comprising an epoxidized synthetic rubber (ESR) having an epoxy function content ranging from 7% to 25%, on a reinforcing filler, of which at least 50% by weight of the reinforcing filler is constituted of an inorganic filler, and on a plasticizing agent comprising a polar liquid plasticizer.

The rubber composition used within the context of the invention has a first essential feature of comprising at least one epoxidized synthetic diene rubber (abbreviated to ESR). The term “ESR” according to the invention should be understood to mean an epoxidized synthetic diene rubber or a mixture of several epoxidized synthetic diene rubbers.

The term “diene” elastomer or rubber should be understood, in a known manner, to mean an elastomer resulting at least in part (i.e., a homopolymer or a copolymer) from diene monomers (monomers bearing two carbon-carbon double bonds which may or may not be conjugated).

The expression “diene elastomer” should be understood according to the invention to mean any synthetic elastomer resulting at least partly from diene monomers. More particularly, the expression “diene elastomer” is understood to mean any homopolymer obtained by polymerization of a conjugated diene monomer having 4 to 12 carbon atoms, or any copolymer obtained by copolymerization of one or more conjugated dienes with one another or with one or more vinylaromatic compounds having from 8 to 20 carbon atoms. In the case of copolymers, these contain from 20% to 99% by weight of diene units, and from 1% to 80% by weight of vinylaromatic units.

Suitable conjugated dienes that can be used in the process in accordance with the invention are, in particular, 1,3-butadiene, 2-methyl-1,3-butadiene, 2,3-di(C₁-C₅)alkyl-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, phenyl-1,3-butadiene, 1,3-pentadiene, 2,4-hexadiene, etc.

Suitable vinylaromatic compounds are, in particular, styrene, ortho-, meta- and para-methylstyrene, the commercial “vinyl-toluene” mixture, para-(tert-butyl)styrene, methoxy-styrenes, vinylmesitylene, divinylbenzene, vinylnaphthalene, etc.

The following are suitable: polybutadienes and in particular those having a content (mol %) of 1,2-units of between 4% and 80% or those having a content (mol %) of cis-1,4-units of greater than 80%, polyisoprenes, butadiene-styrene copolymers and in particular those having a T_{g} (glass transition temperature, measured according to ASTM D3418) of between 0° C. and −70° C. and more particularly between −10° C. and −60° C., a styrene content of between 5% and 60% by weight and more particularly between 20% and 50%, a content (mol %) of 1,2-bonds of the butadiene part of between 4% and 75% and a content (mol %) of trans-1,4-bonds of between 10% and 80%, butadiene-isoprene copolymers and in particular those having an isoprene content of between 5% and 90% by weight and a T_{g} from −40° C. to −80° C., or isoprene-styrene copolymers and in particular those having a styrene content of between 5% and 50% by weight and a T_{g} of between −25° C. and −50° C. In the case of butadiene-styrene-isoprene copolymers, suitable ones are especially those having a styrene content of between 5% and 50% by weight and more particularly between 10% and 40%, an isoprene content of between 15% and 60% by weight and more particularly between 20% and 50%, a butadiene content of between 5% and 50% by weight and more particularly between 20% and 40% a content (mol %) of 1,2-units of the butadiene part of between 4% and 85%, a content (mol %) of trans-1,4-units of the butadiene part of between 6% and 80%, a content (mol %) of 1,2-units plus 3,4-units of the isoprene part of between 5% and 70% and a content (mol %) of trans-1,4-units of the isoprene part of between 10% and 50%, and more generally any butadiene-styrene-isoprene copolymer having a T_{g} of between −20° C. and −70° C.

In summary, the diene elastomer of the composition in accordance with the invention is preferably chosen from the group of highly unsaturated diene elastomers consisting of polybutadienes (abbreviated to “BR”), synthetic polyisoprenes (IR), natural rubber (NR), butadiene copolymers, isoprene copolymers and mixtures of these elastomers. Such copolymers are more preferably chosen from the group consisting of butadiene-styrene copolymers (SBR), isoprene-butadiene copolymers (BIR), isoprene-styrene copolymers (SIR) and isoprene-butadiene-styrene copolymers (SBIR), and more particularly still among these, SBR, SIR and SBIR.

The epoxidized synthetic diene rubbers (ESR) in accordance with the invention preferably have a T_{g} between −10° C. and −60° C., and more particularly ranging from −20° C. to −40° C.

The epoxidized synthetic diene rubbers (ESR) may be obtained, as is known per se, by epoxidation of synthetic diene elastomers, for example by processes based on chlorohydrin or bromohydrin or processes based on hydrogen peroxides, alkyl hydroperoxides or peracids (such as peracetic acid or performic acid).

To obtain the targeted technical effect, the degree of epoxidation (mol %) of the ESR is within a range extending from 7% to 25%. When the degree of epoxidation is less than 7%, the targeted technical effect (improvement in the grip on wet ground) runs the risk of being insufficient; above 25%, the targeted technical effect is certainly improved, but tan (δ) at 40° C. increases, i.e. the rolling resistance is penalized. For these reasons, the degree of epoxidation of the ESR should be within a range extending from 7% to 25%. It is preferably within a range extending from 7% to 15%. Indeed, in this range it is possible to observe not only an improvement in the grip on wet ground, but also a very unexpected improvement in the hysteresis properties and therefore a reduction in the rolling resistance.

The rubber composition used within the context of the invention preferably comprises more than 40 phr of ESR; more preferably still, the ESR content is within a range extending from 50 to 100 phr, in particular within a range extending from 70 to 100 phr.

The ESR rubber may be constituted, according to the invention, of a mixture of several epoxidized synthetic diene rubbers in accordance with the invention.

The above ESR rubber may be combined with one or more other diene elastomer(s) conventionally used in tyre covers and chosen from natural rubber and the synthetic diene elastomers, optionally coupled and/or star-branched and/or functionalized, in a manner known per se, using a functionalizing, coupling or star-branching agent, and mixtures of these elastomers.

This or these other diene elastomers are then present in the matrix in a content between 0 and 60 phr (the limits of this range being excluded), preferably in a content ranging from more than 0 to 50 phr, more preferably still from more than 0 to 30 phr.

In the case of a blend with at least one other diene elastomer, the weight fraction of ESR in the elastomeric matrix is the predominant fraction and is preferably greater than or equal to 50% by weight of the total weight of the matrix. The predominant weight fraction according to the invention refers to the highest weight fraction of the blend.

It will be noted that the improvement in the properties of the rubber composition according to the invention will be even higher when the proportion of said additional elastomer(s) in the composition according to the invention is lower.

The rubber composition according to the invention also comprises a reinforcing filler, of which at least 50% by weight of the reinforcing filler is constituted of an inorganic filler.

The term “reinforcing inorganic filler” should be understood in the present patent application, by definition, as meaning any inorganic or mineral filler (whatever its colour or its origin (natural or synthetic)), also known as “white filler”, “clear filler”, or even “non-black filler”, in contrast to carbon black, capable of reinforcing by itself alone, without means other than an intermediate coupling agent, a rubber composition intended for the manufacture of tyres, in other words capable of replacing, in its reinforcing role, a conventional tyre-grade carbon black; such a filler is generally characterized, in a known way, by the presence of hydroxyl (—OH) groups at its surface.

The physical state in which the reinforcing inorganic filler is provided is not important, whether it is in the form of a powder, of microbeads, of granules, of balls or any other appropriate densified form. Of course, the expression “reinforcing inorganic filler” is also understood to mean mixtures of various reinforcing inorganic fillers, in particular of highly dispersible siliceous and/or aluminous fillers as described below.

Mineral fillers of the siliceous type, in particular silica (SiO₂), or of the aluminous type, in particular alumina (Al₂O₃), are suitable in particular as reinforcing inorganic fillers. The silica used may be any reinforcing silica known to a person skilled in the art, in particular any precipitated or pyrogenic silica having a BET surface area and a CTAB specific surface area that are both less than 450 m²/g, preferably from 30 to 400 m²/g. Mention will be made, as highly dispersible precipitated silicas (“HDSs”), for example, of the Ultrasil 7000 and Ultrasil 7005 silicas from Degussa, the Zeosil 1165 MP, 1135 MP and 1115 MP silicas from Rhodia, the Hi-Sil EZ150G silica from PPG, the Zeopol 8715, 8745 and 8755 silicas from Huber or the silicas with a high specific surface area as described in patent application WO 03/16837.

The reinforcing inorganic filler used, in particular if it is silica, preferably has a BET surface area of between 45 and 400 m²/g, more preferably of between 60 and 300 m²/g.

It is possible to use, as a blend with this reinforcing inorganic filler, an organic filler such as carbon black.

All carbon blacks, in particular blacks of the HAF, ISAF or SAF type, conventionally used in tyres (“tyre-grade” blacks) are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks, or else, depending on the applications targeted, the blacks of higher series (for example, N660, N683 or N772). The carbon blacks might, for example, be already incorporated in an isoprene elastomer in the form of a masterbatch (see, for example, patent applications WO 97/36724 or WO 99/16600).

Mention may be made, as examples of organic fillers other than carbon blacks, of the functionalized polyvinyl organic fillers as described in patent applications WO-A-2006/069792, WO-A-2006/069793, WO-A-2008/003434 and WO-A-2008/003435.

Preferably, the content of total reinforcing filler (reinforcing inorganic filler, such as silica and/or organic filler, such as carbon black) is greater than or equal to 50 phr, more preferably from 50 to 150 phr (including these limits). The optimum being, in a known manner, different depending on the particular applications targeted: the level of reinforcement expected with regard to a bicycle tyre, for example, is, of course, less than that required with regard to a tyre capable of running at high speed in a sustained manner, for example a motorcycle tyre, a tyre for a passenger vehicle or for a utility vehicle, such as a heavy vehicle.

According to one preferential embodiment of the invention, use is made of a reinforcing filler comprising from 50 to 150 phr (including these limits), preferably from 50 to 130 phr of inorganic filler, particularly silica, and optionally an organic filler such as carbon black; the carbon black, when it is present, is preferably used at a content less than or equal to 20 phr, more preferably less than 10 phr (for example between 0.1 and 10 phr).

In order to couple the reinforcing inorganic filler to the diene elastomer, use is made, in a known manner, of an at least bifunctional coupling agent (or bonding agent) intended to provide a satisfactory connection, of chemical and/or physical nature, between the inorganic filler (surface of its particles) and the diene elastomer, in particular bifunctional organosilanes or polyorganosiloxanes.

Use is made in particular of silane polysulphides, referred to as “symmetrical” or “asymmetrical” depending on their specific structure, as described, for example, in applications WO 03/002648 (or US 2005/016651) and WO 03/002649 (or US 2005/016650).

Suitable in particular, without the definition below being limiting, are silane polysulphides corresponding to the following general formula (I):

Z-A-Sₓ-A-Z, in which: (I)
x is an integer from 2 to 8 (preferably from 2 to 5);
the A symbols, which are identical or different, represent a divalent hydrocarbon-based radical (preferably, a C₁-C₁₈ alkylene group or a C₆-C₁₂ arylene group, more particularly a C₁-C₁₀, in particular C₁-C₄, alkylene, in particular propylene);
the Z symbols, which are identical or different, correspond to one of the three formulae below:

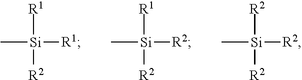

in which:
the substituted or unsubstituted R¹ radicals, which are identical to or different from one another, repressent a C₁-C₁₈ alkyl, C₅-C₁₈ cycloalkyl or C₅-C₁₈ aryl group (preferably C₁-C₆ alkyl, cyclohexyl or phenyl groups, in particular C₁-C₄ alkyl groups, more particularly methyl and/or ethyl);
the substituted or unsubstituted R² radicals, which are identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferably still a group chosen from C₁-C₄ alkoxyls, in particular methoxyl and ethoxyl).

In the case of a mixture of alkoxysilane polysulphides corresponding to the above formula (I), in particular the usual mixtures available commercially, the mean value of the “x” index is a fractional number preferably between 2 and 5, more preferably in the vicinity of 4. However, the invention may also advantageously be carried out, for example, with alkoxysilane disulphides (x=2).

Mention will more particularly be made, as examples of silane polysulphides, of bis((C₁-C₄)alkoxyl(C₁-C₄)alkylsilyl(C₁-C₄)alkyl)polysulphides (in particular disulphides, trisulphides or tetrasulphides), such as, for example, bis(3-trimethoxysilylpropyl) or bis(3-triethoxysilylpropyl)polysulphides. Use is in particular made, among these compounds, of bis(3-triethoxysilylpropyl)tetrasulphide, abbreviated to TESPT, of formula [(C₂H₅O)₃Si(CH₂)₃S₂]₂ or bis(triethoxysilylpropyl)disulphide, abbreviated to TESPD, of formula [(C₂H₅O)₃Si(CH₂)₃S]₂. Mention will also be made, as preferred examples, of bis(mono(C₁-C₄)alkoxyldi(C₁-C₄)alkylsilylpropyl)polysulphides (in particular disulphides, trisulphides or tetrasulphides), more particularly bis(monoethoxydimethylsilylpropyl) tetrasulphide, as described in the aforementioned patent application WO 02/083782 (or U.S. Pat. No. 7,217,751).

Mention will in particular be made, as examples of coupling agents other than an alkoxysilane polysulphide, of bifunctional POSs (polyorganosiloxanes) or else of hydroxysilane polysulphides (R²═OH in formula I above) such as described, for example, in patent applications WO 02/30939 (or U.S. Pat. No. 6,774,255), WO 02/31041 (or US 2004/051210) and WO 2007/061550, or else of silanes or POSs bearing azodicarbonyl functional groups, such as described, for example, in patent applications WO 2006/125532, WO 2006/125533 and WO 2006/125534.

Mention will be made, as examples of other silane sulphides, of, for example, the silanes bearing at least one thiol (—SH) function (known as mercaptosilanes) and/or at least one blocked thiol function, as described, for example, in patents or patent applications U.S. Pat. No. 6,849,754, WO 99/09036, WO 2006/023815 and WO 2007/098080.

Of course, mixtures of the coupling agents described previously could also be used, as described in particular in the aforementioned patent application WO 2006/125534.

In the protective elastomer layers, when they are reinforced by an inorganic filler such as silica, the content of coupling agent preferably ranges from 4 to 15 phr, more preferably from 4 to 12 phr.

A person skilled in the art will understand that, as equivalent filler to the reinforcing inorganic filler described in the present section, a reinforcing filler of another nature, in particular organic nature, could be used provided that this reinforcing filler is covered with an inorganic layer, such as silica, or else comprises functional sites, in particular hydroxyl sites, at its surface that require the use of a coupling agent in order to form the bond between the filler and the elastomer.

The rubber composition according to the invention also comprises, as essential component, a plasticizing agent comprising a polar liquid plasticizer. The expression “polar liquid plasticizer” is also understood to mean that the plasticizing agent may comprise a mixture of two or more polar liquid plasticizers. The use of this polar liquid plasticizing agent proves to be beneficial to other mechanical properties of the rubber composition, which imparts, for example, to the tyre that incorporates it into its tread, an improved resistance with respect to abrasion.

The expression “liquid plasticizer” is understood, in a known manner, to mean a plasticizer that is liquid at 20° C., referred to as a “low T_{g} plasticizer”, i.e. which has, by definition, a T_{g} of below −20° C., preferably of below −40° C. Liquid plasticizers, which are preferably non-aromatic or very weakly aromatic, may be split into two categories: polar plasticizers and non-polar plasticizers.

Among these non-polar plasticizers, mention may be made of naphthenic oils, especially hydrogenated naphthenic oils, paraffinic oils, MES (mild extract solvate) oils, HPD (hydrogenated paraffinic distillation) oils or TDAE (treated distillate aromatic extract) oils and mixtures of these compounds.

Among the polar plasticizers, mention may be made of ester and ether plasticizers, phosphate and sulphonate plasticizers and mixtures of these compounds. Particularly preferred are the compounds chosen from the group formed by phosphates, trimellitates, pyromellitates, phthalates, 1,2-cyclohexane dicarboxylates, adipates, azelates, sebacates, glycerol triesters and mixtures of these compounds. Among the glycerol triesters, glycerol trioleates and more particularly oleic sunflower oil, are preferred.

Thus, according to one preferential aspect of the invention, the plasticizing agent comprising a polar liquid plasticizer more particularly comprises a glycerol triester, such as oleic sunflower oil.

According to one embodiment of the invention, the plasticizing agent may comprise, besides the polar liquid plasticizer, a non-polar liquid plasticizer as described above.

According to another embodiment of the invention, the plasticizing agent may comprise, besides the polar liquid plasticizer, a solid hydrocarbon-based resin. In a manner known to a person skilled in the art, the term “resin” is reserved in the present application, by definition, for a compound which is a solid at room temperature (23° C.) (as opposed to a liquid plasticizer compound such as an oil). This resin has a T_{g} above 0° C., preferably above +20° C.

The hydrocarbon-based resins may be aliphatic or aromatic or else of aliphatic/aromatic type, i.e. based on aliphatic and/or aromatic monomers. They may be natural or synthetic, and may or may not be based on petroleum (if such is the case, they are also known under the name of petroleum resins).

By way of example, the hydrocarbon-based plasticizing resin is chosen from the group formed by cyclopentadiene (abbreviated to CPD) or dicyclopentadiene (abbreviated to DCPD) homopolymer or copolymer resins, terpene homopolymer or copolymer resins, terpene-phenol homopolymer or copolymer resins, C₅-cut homopolymer or copolymer resins, C₉-cut homopolymer or copolymer resins and mixtures of these resins. Mention will especially be made, among these hydrocarbon-based plasticizing resins of terpene type, of α-pinene, β-pinene, dipentene or polylimonene homopolymer or copolymer resins.

The content of plasticizer is preferably within a range from 5 to 70 phr. Below the indicated minimum, the targeted technical effect may prove insufficient, whereas above the maximum, the tack of the compositions in the uncured state, with respect to the compounding tools, may, in certain cases, become unacceptable from an industrial viewpoint. For these reasons, the content of plasticizer is more preferably within a range from 10 to 40 phr, particularly from 15 to 35 phr.

The rubber composition in accordance with the invention may also comprise all or some of the usual additives customarily used in elastomer compositions intended in particular for the manufacture of treads, such as, for example, pigments, protection agents, such as antiozone waxes, chemical antiozonants, antioxidants, antifatigue agents, reinforcing resins, such as methylene acceptors (for example, phenol-novolac resin) or methylene donors (for example, HMT or H3M), a crosslinking system based either on sulphur or on sulphur donors and/or on peroxide and/or on bismaleimides, vulcanization accelerators and vulcanization activators.

These compositions may, in addition to coupling agents, also contain coupling activators, agents for covering the inorganic fillers, or more generally processing aids capable, in a known manner, owing to an improvement in the dispersion of the filler in the rubber matrix and to a lowering in the viscosity of the compositions, of improving their ability to be processed in the uncured state, these agents being, for example, hydrolysable silanes such as alkylalkoxysilanes, polyols, polyethers, primary, secondary or tertiary amines or hydroxylated or hydrolysable polyorganosiloxanes.

The rubber compositions used within the context of the invention may be manufactured in appropriate mixers using two successive preparation phases well known to a person skilled in the art: a first phase of thermomechanical working or kneading (referred to as a “non-productive” phase) at high temperature, up to a maximum temperature of between 110° C. and 190° C., preferably between 130° C. and 180° C., followed by a second phase of mechanical working (referred to as a “productive” phase) up to a lower temperature, typically below 110° C., for example between 40° C. and 100° C., finishing phase during which the cros slinking system is incorporated.

The process for preparing such compositions comprises, for example, the following stages:
incorporating into an ESR diene elastomer, during a first stage (referred to as a “non-productive” stage), at least one reinforcing filler and one plasticizing agent comprising a polar liquid plasticizer, everything being kneaded thermomechanically (for example in one or more steps), until a maximum temperature of between 110° C. and 190° C. is reached;
cooling the combined mixture to a temperature below 100° C.;
subsequently incorporating, during a second stage (referred to as a “productive” stage), a crosslinking system;
kneading everything up to a maximum temperature below 110° C.

By way of example, the non-productive phase is carried out in a single thermomechanical stage during which, in a first step, all the necessary base constituents (ESR and optional other diene elastomer, plasticizing agent, reinforcing filler and coupling agent) are introduced into an appropriate mixer, such as a standard internal mixer, followed, in a second step, for example after kneading for one to two minutes, by the other additives, optional additional filler-covering agents or processing aids, with the exception of the crosslinking system. The total kneading time, in this non-productive phase, is preferably between 1 and 15 min.

After cooling the mixture thus obtained, the crosslinking system is then incorporated in an external mixer, such as an open mill, maintained at a low temperature (for example, between 40° C. and 100° C.). The combined mixture is then mixed (productive phase) for a few minutes, for example between 2 and 15 min.

The final composition thus obtained may then be calendered, for example in the form of a sheet or a slab, in particular for laboratory characterization, or else is extruded, for example to form a rubber profiled element used for manufacturing a tread.

The invention relates to the rubber compositions, tyres and tyre treads described above, both in the uncured state (i.e., before curing) and in the cured state (i.e., after crosslinking or vulcanization).

The aforementioned features of the present invention, and others, will be better understood on reading the following description of several exemplary embodiments of the invention, given by way of illustration and without implied limitation.

### EXEMPLARY EMBODIMENTS OF THE INVENTION

### I—Measurements and Tests Used

I.1—Dynamic Properties

The dynamic properties are measured on a viscosity analyzer (Metravib VA4000) according to the standard ASTM D 5992-96. The response of a sample of vulcanized composition (cylindrical test specimen with a thickness of 4 mm and with a cross section of 400 mm²), subjected to a simple alternating sinusoidal shear stress, at a frequency of 10 Hz, is recorded during a temperature sweep at a fixed stress of 0.7 MPa; the value of tan(δ) observed at 0° C. and the value of tan(δ) observed at 40° C. are recorded.

It is recalled, as is well known to a person skilled in the art, that the value of tan(δ) at 0° C. is representative of the potential to grip on wet ground: the higher tan(δ) at 0° C., the better the grip. The value of tan(δ) at 40° C. is representative of the hysteresis of the material, and therefore of the rolling resistance: the lower tan(δ) at 40° C., the lower the rolling resistance.

### II—Production of the Compositions and Tests

### II.1—Preparation of the Compositions

The tests which follow are carried out in the following manner: 2/3 of the filler (silica and carbon black), the coupling agent in the presence of silica and the ESR are introduced, at 0 min, into an internal mixer of around 3 litres (final fill ratio: around 70% by volume), the initial vessel temperature of which is around 70° C. Thermomechanical working (non-productive phase) is then carried out in one stage with a speed of the kneader arms of 50 rpm until a temperature of 95° C. is reached. When the temperature of 95° C. is reached, the last ⅓ of the filler, the plasticizing agent, and also the various other ingredients including one accelerator if several accelerators are used, are added, with the exception, on the one hand, of the vulcanization system and, on the other hand, of ZnO, while continuing the thermomechanical working, which lasts in total approximately 5 min, in order to reach a maximum “dropping” temperature of 165° C.

The mixture thus obtained is recovered and cooled and then sulphur and an accelerator of sulphenamide type are incorporated in a mixer (homofinisher) at 50° C., the combined mixture being mixed (productive phase) for an appropriate time (for example, between 5 and 12 min).

The compositions thus obtained are subsequently calendered, either in the form of slabs (thickness of 2 to 3 mm) or of fine sheets of rubber, for the measurement of certain properties, or extruded in the form of a tread.

### II.2—Example 1

The tests demonstrate the improvement, in terms of grip on wet ground and rolling resistance, provided by a composition in accordance with the invention, in comparison with a control composition.

In order to do this, seven rubber compositions based on an SBR elastomeric matrix were prepared as indicated previously, eight with an ESR (denoted by B to G) that differ by the different degree of epoxidation of the ESR and one with a non-epoxidized SBR (control denoted by A).

Details of the compositions are summarized in Table 1.

TABLE 1

| | A | | | | | | |
|---|---|---|---|---|---|---|---|
| Components | (Control) | B | C | D | E | F | G |
| SBR elastomer solution (1) | 100 | | | | | | |
| 2% epoxidized SBR solution (2) | | 100 | | | | | |
| 7% epoxidized SBR solution (2) | | | 100 | | | | |
| 15% epoxidized SBR solution (2) | | | | 100 | | | |
| 19% epoxidized SBR solution (2) | | | | | 100 | | |
| 25% epoxidized SBR solution (2) | | | | | | 100 | |
| 30% epoxidized SBR solution (2) | | | | | | | 100 |
| Z1165MP silica from Rhodia (3) | 80 | 80 | 80 | 80 | 80 | 80 | 80 |
| TESPT coupling agent (Si69 | 6.4 | 6.4 | 6.4 | 6.4 | 6.4 | 6.4 | 6.4 |
| Degussa) (4) | | | | | | | |
| N234 (5) | 6 | 6 | 6 | 6 | 6 | 6 | 6 |
| PLASTICIZER (6) | 30 | 30 | 30 | 30 | 30 | 30 | 30 |
| C32ST ozone wax (7) | 1.5 | 1.5 | 1.5 | 1.5 | 1.5 | 1.5 | 1.5 |
| Antioxidant (6PPD) (8) | 1.9 | 1.9 | 1.9 | 1.9 | 1.9 | 1.9 | 1.9 |
| Diphenylguanidine (DPG) (9) | 1.5 | 1.5 | 1.5 | 1.5 | 1.5 | 1.5 | 1.5 |
| ZnO (10) | 2.5 | 2.5 | 2.5 | 2.5 | 2.5 | 2.5 | 2.5 |
| Stearic acid (11) | 2 | 2 | 2 | 2 | 2 | 2 | 2 |
| Sulphur | 1.1 | 1.1 | 1.1 | 1.1 | 1.1 | 1.1 | 1.1 |
| CBS (12) | 2 | 2 | 2 | 2 | 2 | 2 | 2 |

(1) SBR solution with 40% of styrene and having a T_{g} of −30° C. (s-SBR).
(2) SBR solution with 40% of styrene and with various epoxy function contents;
(3) silica: “Zeosil 1165 MP” from Rhodia, of “HD” type (BET and CTAB: around 160 m²/g);
(4) TESPT coupling agent (“Si69” from Degussa);
(5) N234 carbon black (ASTM grade);
(6) glycerol trioleate (sunflower oil with 85% by weight of oleic acid, “lubrirob Tod 1880” from Novance);
(7) C32ST ozone wax;
(8) N-1,3-dimethylbutyl-N-phenyl-para-phenylenediamine (Santoflex 6-PPD from Flexsys);
(9) Diphenylguanidine (“Perkacit DPG” from Flexsys);
(10) zinc oxide (industrial grade - Umicore);
(11) stearine (“Pristerene” from Uniquema);
(12) N-cyclohexyl-2-benzothiazyl sulphenamide (Santocure CBS from Flexsys).

The mechanical properties of the compositions are summarized respectively in Table 2.

TABLE 2

| | A | | | | | | |
|---|---|---|---|---|---|---|---|
| Composition | (Control) | B | C | D | E | F | G |
| tan (δ) at 0° C. | 0.43 | 0.42 | 0.48 | 0.67 | 0.85 | 0.99 | 0.93 |
| (0.7 MPa) | | | | | | | |
| tan (δ) at 40° C. | 0.21 | 0.20 | 0.18 | 0.18 | 0.21 | 0.20 | 0.25 |
| (0.7 MPa) | | | | | | | |

It is noted that compositions C, D, E and F in accordance with the invention display a higher level of tan(δ) at 0° C. than the control composition B, at the same time as either an improvement in the dynamic properties at 40° C., or a constancy of said properties. It is noted that composition B, based on an ESR which does not have sufficient epoxy functions (2%), does not make it possible to improve the grip on wet ground, whereas composition G, based on an ESR which has too many epoxy functions, certainly makes it possible to obtain the targeted effect but at the expense of a severe deterioration of the rolling resistance.

The improvement of the grip on wet ground is very significantly improved at constant rolling resistance, knowing that a person skilled in the art considers an improvement of 0.02 of the level of tan(δ) to be a real improvement in tyre performance level.

It is noted that the compositions based on SBR that are epoxidized in accordance with the invention exhibit dynamic properties that are unexpectedly substantially improved when the degree of epoxidation of the ESRs ranges from 7% to 25%:
with a value of tan(δ) at 0° C. that is markedly higher than that of the control composition A, a recognized indicator of improved grip on wet ground; and
with, on the one hand, a value of tan(δ) at 40° C. that is substantially unchanged or even simultaneously improved relative to that of the control composition A, synonymous, for a person skilled in the art, with an unchanged hysteresis and therefore with an unchanged rolling resistance.

It may be concluded, by comparing the results from this table, that the use, in a tyre tread, of the combination of epoxidized diene elastomers and polar plasticizing oil makes it possible to maximize the grip on wet ground without impairing the rolling resistance and to obtain an improved compromise of properties with respect to the grip on wet ground and the rolling resistance.

### II.3—Example 2

Three rubber compositions based on a PI elastomeric matrix were prepared as indicated previously, two in accordance with the invention (denoted by I and J) and one not in accordance with the invention (control denoted hereinbelow by H).

The compositions I and J in accordance with the invention comprise 100 phr of ESR and differ by the different degree of epoxidation of the ESR. The control composition H comprises 100 phr of unfunctionalized PI and a plasticizing agent.

Formulation details of the compositions are summarized in Table 3.

TABLE 3

| | H | | |
|---|---|---|---|
| Components | (Control) | I | J |
| PI elastomer (1) | 100 | | |
| 12% epoxidized PI (2) | | 100 | |
| 25% epoxidized PI (2) | | | 100 |
| Silica (3) | 80 | 80 | 80 |
| Coupling agent (4) | 6.4 | 6.4 | 6.4 |
| Black (5) | 6 | 6 | 6 |
| PLASTICIZER (6) | 30 | 30 | 30 |
| C32ST ozone wax (7) | 1.5 | 1.5 | 1.5 |
| Antioxidant (8) | 1.9 | 1.9 | 1.9 |
| Diphenylguanidine (9) | 1.5 | 1.5 | 1.5 |
| ZnO (10) | 2.5 | 2.5 | 2.5 |
| Stearic acid (11) | 2 | 2 | 2 |
| Sulphur | 1.1 | 1.1 | 1.1 |
| CBS (12) | 2 | 2 | 2 |

(1) Polyisoprene with 40% of 3,4-IR and having a T_{g} of −36° C.;
(2) Polyisoprene with 40% of 3,4-IR and with various epoxy function contents;
(3) silica: “Zeosil 1165 MP” from Rhodia, of “HD” type (BET and CTAB: around 160 m²/g);
(4) TESPT coupling agent (“Si69” from Degussa);
(5) N234 carbon black (ASTM grade);
(6) glycerol trioleate (sunflower oil with 85% by weight of oleic acid, “lubrirob Tod 1880” from Novance);
(7) C32ST ozone wax;
(8) N-1,3-dimethylbutyl-N-phenyl-para-phenylenediamine (Santoflex 6-PPD from Flexsys);
(9) Diphenylguanidine (“Perkacit DPG” from Flexsys);
(10) zinc oxide (industrial grade - Umicore);
(11) stearine (“Pristerene” from Uniquema);
(12) N-cyclohexyl-2-benzothiazyl sulphenamide (Santocure CBS from Flexsys).

The mechanical properties are summarized respectively in Table 4.

TABLE 4

| | H | | |
|---|---|---|---|
| Composition | (Control) | I | J |
| tan (δ) at 0° C. (0.7 MPa) | 0.55 | 0.69 | 1.15 |
| tan (δ) at 40° C. (0.7 MPa) | 0.22 | 0.17 | 0.21 |

The compositions I and J, in accordance with the invention, display a higher level of tan(δ) at 0° C. than the control composition H, without significant modification of the dynamic properties. The use of PI epoxidized to degrees respectively of 12% and 25% makes it possible to greatly increase the dissipation at 0° C., and consequently the grip on wet ground, while improving the dynamic property tan(δ) at 40° C., i.e. the rolling resistance of a tread produced with such compositions.

Moreover, the results of these tests show that the combined use of a polar synthetic rubber, such as an epoxidized SBR or PI, with a polar liquid plasticizing agent, is beneficial for maximizing the gain in tan(δ) at 0° C. and makes it possible to obtain an improved compromise of properties, favourable to the grip on wet ground and to the rolling resistance of tyre treads produced using such a composition.

1. A rubber composition based at least on an elastomeric matrix comprising an epoxidized synthetic rubber (ESR) having an epoxy function content ranging from 7% to 25%, on a reinforcing filler comprising an inorganic filler in a weight fraction of at least 50% and on a plasticizing agent comprising a polar liquid plasticizer.

2. The rubber composition according to claim 1, wherein the ESR has a T₉ between −10° C. and −60° C.

3. The rubber composition according to claim 2, wherein the ESR has a T_{g} from −20° C. to −40° C.

4. The rubber composition according to claim 1, wherein the ESR rubber is present in the elastomeric matrix as the predominant elastomer.

5. The rubber composition according to claim 4, wherein the ESR rubber content is within a range extending from 50 to 100 phr.

6. The rubber composition according to claim 1, wherein the ESR is a copolymer chosen from butadiene-styrene copolymers (SBR), isoprene-styrene copolymers (SIR) and isoprene-butadiene-styrene copolymers (SBIR) or a synthetic polyisoprene, and that has been epoxidized.

7. The rubber composition according to claim 1, wherein the plasticizing agent consists of the polar liquid plasticizer.

8. The rubber composition according to claim 1, wherein the plasticizing agent further comprises, besides the polar liquid plasticizer, at least one other plasticizer chosen from non-polar liquid plasticizers and solid plasticizing resins.

9. The rubber composition according to claim 1, wherein the polar liquid plasticizer is an oleic sunflower oil.

10. The rubber composition according to claim 1, wherein the elastomeric matrix further comprises a diene elastomer selected from the group consisting of natural rubber, synthetic diene elastomers, coupled and/or star-branched and/or functionalized synthetic diene elastomers, and mixtures of these elastomers.

11. The rubber composition according to claim 1, wherein the amount of reinforcing inorganic filler is between 50 and 150 phr.

12. The rubber composition according to claim 11, wherein the reinforcing inorganic filler is silica.

13. Tire tread comprising a rubber composition according to claim 1.

14. Tire comprising a tread according to claim 13.

15. Process for achieving a compromise of improved properties of grip on wet ground and of rolling resistance of a tire, consisting of:
the preparation of a rubber composition based on an elastomeric matrix comprising an epoxidized rubber (ESR) having an epoxy function content ranging from 7% to 25%, a reinforcing filler and, as plasticizing agent, a polar liquid plasticizer,
producing a tire tread via extrusion, and
manufacturing a tire comprising said tread.
